(19) United States
(12) Patent Application Publication
(10) Pub. No.: US 2026/0302256 A1
(43) Pub. Date: Oct. 1, 2026

(54) ALL-SOLID-STATE BATTERY AND METHOD OF MANUFACTURING ALL-SOLID-STATE BATTERY

(71) Applicant: HONDA MOTOR CO., LTD., Tokyo (JP)

(72) Inventors: Tatsuya HASHIMOTO, Saitama (JP); Takashi TOMIDA, Saitama (JP); Daichi TANAKA, Saitama (JP); Takahiro IMAJO, Saitama (JP); Atsuhiro NISHIDA, Saitama (JP); Hiroshi AKUTSU, Saitama (JP); Hotaka HIRATA, Saitama (JP); Yuichi TAJIRI, Saitama (JP); Tetsuhiro TAKEHARA, Saitama (JP)

(21) Appl. No.: 19/554,666

(22) Filed: Mar. 3, 2026

(30) Foreign Application Priority Data
Mar. 31, 2025 (JP) 2025-059231

(51) Int. Cl. H01M 4/66; H01M 4/02; H01M 4/04; H01M 4/36; H01M 4/505; H01M 4/525; H01M 10/0585

(52) U.S. Cl. CPC H01M 4/662; H01M 4/043; H01M 4/0471; H01M 4/366; H01M 4/505; H01M 4/525; H01M 10/0585; H01M 2004/021; H01M 2004/028

(57) ABSTRACT

Provided are an all-solid-state battery with excellent durability and a method of manufacturing the same. The positive electrode current collector layer 21 includes a positive electrode current collector layer-main body 22 that overlaps with the positive electrode active material layer 25 in a T direction, and a positive electrode tab 24 that extends from the positive electrode current collector layer-main body 22 toward a X+ direction. The positive electrode current collector layer 21 is constituted of a polycrystalline body. A first region R1 defined in the positive electrode tab 24 and including a boundary portion between the positive electrode tab 24 and the positive electrode current collector layer-main body 22 has a larger average grain size of the polycrystalline body than the positive electrode current collector layer-main body 22. The average grain size of the polycrystalline body in the first region R1 is less than 3.0 μm.

This application is based on and claims the benefit of priority from Japanese Patent Application No. 2025-059231, filed on 31 Mar. 2025, the content of which is incorporated herein by reference.

### BACKGROUND OF THE INVENTION

### Field of the Invention

The present invention relates to an all-solid-state battery and a method of manufacturing an all-solid-state battery.

### Related Art

In recent years, research and development of secondary batteries that contribute to energy efficiency has been carried out in order to ensure many people have access to affordable, reliable, sustainable, and advanced energy.

Among the secondary batteries, all-solid-state batteries including a solid electrolyte are particularly receiving attention because they have an excellent feature of providing high safety due to the non-flammable nature of the solid electrolyte and having higher energy density. Studies are being conducted on an all-solid-state battery that has a laminated structure in which a plurality of positive electrode layers and negative electrode layers are alternately laminated with solid electrolyte layers interposed therebetween (for example, Japanese Unexamined Patent Application, Publication No. 2022-104116).
Patent Document 1: Japanese Unexamined Patent Application, Publication No. 2022-104116

### SUMMARY OF THE INVENTION

In an all-solid-state battery, current collector tabs extending from current collectors are bundled. The all-solid-state battery expands or contracts in association with charge and discharge. When the all-solid-state battery of Japanese Unexamined Patent Application, Publication No. 2022-104116 expands, the current collector tabs (current collectors) are brought into a pulled state. Due to repetition of charge and discharge of the all-solid-state battery, the current collectors are repeatedly pulled and may eventually fracture.

It is an object of the present invention to provide an all-solid-state battery capable of improving durability and a method of manufacturing the all-solid-state battery.
(1) A first aspect of the present invention is directed to an all-solid-state battery including a negative electrode layer and a positive electrode layer laminated together with a solid electrolyte layer interposed therebetween, the positive electrode layer having a positive electrode active material layer and a positive electrode current collector layer. A direction in which the negative electrode layer and the positive electrode layer are laminated is defined as a laminating direction, and one direction among directions orthogonal to the laminating direction is defined as a first direction. The positive electrode current collector layer includes a positive electrode current collector layer-main body and a positive electrode tab, the positive electrode current collector layer-main body overlapping with the positive electrode active material layer in the laminating direction, the positive electrode tab extending from the positive electrode current collector layer-main body toward one side in the first direction. The positive electrode current collector layer is constituted of a polycrystalline body. A first region defined in the positive electrode tab and including a boundary portion between the positive electrode tab and the positive electrode current collector layer-main body has an average grain size of the polycrystalline body that is larger than an average grain size of the polycrystalline body of the positive electrode current collector layer-main body, and the average grain size of the polycrystalline body in the first region is less than 3.0 μm.

Among regions of the positive electrode current collector layer, a region near the root of the positive electrode tab is considered to easily fracture because the region is likely to be affected by expansion and contraction of the all-solid-state battery. The all-solid-state battery described in (1), in which the first region having a relatively large average grain size of the polycrystalline body is formed in the region near the root of the positive electrode tab, makes it possible to increase the strength of the region near the root of the positive electrode. Furthermore, since the average grain size of the polycrystalline body in the first region is less than 3.0 μm, sufficient flexibility of the positive electrode tab can be ensured. This makes it possible to reduce or prevent fracture of the positive electrode current collector layer. Thus, the all-solid-state battery having excellent durability can be provided.

If the average grain size of the polycrystalline body of the positive electrode current collector layer increases, electrical resistance in the positive electrode current collector layer will increase, and battery performance of the all-solid-state battery may deteriorate. According to the all-solid-state battery described in (1) above, in which the positive electrode current collector layer-main body has a small average grain size of the polycrystalline body, an increase in electrical resistance in the positive electrode current collector layer-main body can be reduced or prevented.

Furthermore, since the positive electrode current collector layer-main body is laminated on other layers, the positive electrode current collector layer-main body is less likely to give rise to a problem pertaining to its strength. Therefore, it is possible to improve the durability of the all-solid-state battery while ensuring battery performance of the all-solid-state battery.

Furthermore, since the average grain size of the polycrystalline body in the first region is less than 3.0 μm, an increase in electrical resistance in the first region can be reduced or prevented. This makes it possible to more satisfactorily reduce or prevent deterioration of the battery performance of the all-solid-state battery.
(2) According to a second aspect, in the all-solid-state battery described in (1) above, the positive electrode current collector layer may include at least one of aluminum or an aluminum alloy.

In the all-solid-state battery described in (2), since grains of aluminum easily grow by being heated, the first region can be satisfactorily formed by heating the positive electrode current collector layer.

Furthermore, since aluminum has excellent corrosion resistance, it is possible to easily ensure the durability of the positive electrode current collector layer over a long period.
(3) According to a third aspect, in the all-solid-state battery described in (1) or (2) above, a second region defined in the positive electrode tab and located toward a side opposite to the positive electrode current collector layer-main body with respect to the first region may have an average grain size of the polycrystalline body that is smaller than the average grain size of the polycrystalline body in the first region.

The positive electrode tab is joined to another positive electrode tab while being in a bent state, and therefore, it is considered preferable that the positive electrode tab is flexible to an appropriate extent. In particular, it is considered preferable that a region near the leading end of the positive electrode tab is flexible. On the other hand, an increase in the average grain size of the polycrystalline body of the positive electrode tab will harden the positive electrode current collector layer. In such a case, the positive electrode tab may easily experience buckling when the all-solid-state battery expands. However, the all-solid-state battery described in (3), in which the second region near the leading end of the positive electrode tab has a small average grain size of the polycrystalline body, makes it possible to easily ensure the flexibility of the positive electrode tab. In particular, it is possible to easily ensure the flexibility near the leading end of the positive electrode tab. As a result, it is possible to reduce or prevent buckling of the positive electrode current collector layer.
(4) According to a fourth aspect, in the all-solid-state battery described in any one of (1) to (3) above, the first region has an end located toward a side opposite to the positive electrode current collector layer-main body, and the end may be closer to the positive electrode current collector layer-main body than a central portion in the first direction of the positive electrode tab is.

According to the all-solid-state battery described in (4), the positive electrode current collector layer is allowed to have a relatively hard region that reaches a vicinity of its end, thereby making it possible to satisfactorily reduce the likelihood of fracture of the positive electrode current collector layer. Furthermore, by adjusting the position in the first direction of the end of the first region that is toward the side opposite to the positive electrode current collector layer-main body, it is possible to adjust balance between an effect of reducing or preventing fracture of the positive electrode current collector layer and an effect of reducing or preventing buckling of the positive electrode current collector layer.
(5) According to a fifth aspect, in the all-solid-state battery described in any one of (1) to (4) above, the average grain size of the polycrystalline body in the first region may be 0.5 μm or more and less than 3.0 μm.

According to the all-solid-state battery described in (5), the strength of the first region can be easily ensured by increasing the average grain size of the polycrystalline body in the first region to an appropriate extent, thereby making it possible to reduce or prevent the buckling of the positive electrode tab. The flexibility of the first region can be easily ensured by reducing the average grain size of the polycrystalline body in the first region to an appropriate extent, thereby making it possible to reduce or prevent the fracture of the positive electrode tab. As a result, the durability of the all-solid-state battery can be further satisfactorily improved.
(6) According to a sixth aspect, in the all-solid-state battery described in any one of (1) to (5) above, the positive electrode current collector layer may have a thickness of 0.005 mm or more and 0.05 mm or less.

If the thickness of the positive electrode current collector layer is too small, the positive electrode current collector layer would have an insufficient strength. If the thickness of the positive electrode current collector layer is too large, excessive electrical resistance would occur in the positive electrode current collector layer. However, the all-solid-state battery described in (6) makes it possible to more satisfactorily improve the durability of the all-solid-state battery while ensuring the battery performance of the all-solid-state battery.
(7) According to a seventh aspect, in the all-solid-state battery described in any one of (1) to (6) above, the positive electrode active material layer may include a lithium nickel cobalt manganese composite oxide.

According to the all-solid-state battery described in (7), the thermal durability of the positive electrode active material layer can be improved, and therefore, the positive electrode current collector layer and the positive electrode active material layer can be easily heated simultaneously.

The positive electrode active material layer including the lithium nickel cobalt manganese composite oxide may contract during charge of the all-solid-state battery. The contraction of the positive electrode active material layer can suppress expansion of the all-solid-state battery during charge, thereby making it possible to reduce or prevent the fracture of the positive electrode current collector layer.
(8) An eighth aspect of the present invention is directed to a method of manufacturing the all-solid-state battery described in (1) above, the method including a grain growth step that includes preparing a raw material for the positive electrode current collector layer, the raw material being constituted of the polycrystalline body and having the positive electrode current collector layer-main body on which the positive electrode active material layer is to be disposed and having the positive electrode tab extending from the positive electrode current collector layer-main body, and heating the boundary portion between the positive electrode tab and the positive electrode current collector layer-main body to form the first region whose average grain size of the polycrystalline body is larger than that of the positive electrode current collector layer-main body.

Heating the positive electrode current collector layer can produce growth of crystal grains that form the polycrystalline body of the positive electrode current collector layer. According to the method described in (8), by performing the grain growth step, crystal grains forming the polycrystalline body can be grown in a region near the boundary portion between the positive electrode tab and the positive electrode current collector layer-main body, whereby the first region can be formed in the positive electrode current collector layer.
(9) According to a ninth aspect, the method described in (8) above may further include an integration pressing step including superposing and pressing the positive electrode layer, the negative electrode layer, and the solid electrolyte layer, and the grain growth step may be performed before the integration pressing step.

When the positive electrode current collector layer is pressed, the crystal grains in the positive electrode current collector layer may be inhibited from growing. However, the method described in (9) can produce satisfactory growth of the crystal grains in the positive electrode current collector layer, thereby easily allowing the first region and a region of the positive electrode current collector layer other than the first region to have different average grain sizes of the polycrystalline body.
(10) According to a tenth aspect, the method described in (9) above may further include a positive electrode pressing step including pressing the positive electrode active material layer and the positive electrode current collector layer superposed on each other, and the grain growth step may be performed before the positive electrode pressing step.

The method described in (10) can produce more satisfactory growth of the crystal grains in the positive electrode current collector layer, thereby easily allowing the first region and the region of the positive electrode current collector layer other than the first region to have different average grain sizes of the polycrystalline body.

The present invention can provide an all-solid-state battery capable of improving durability.

The present invention can provide a method of manufacturing an all-solid-state battery capable of improving durability.

### BRIEF DESCRIPTION OF THE DRAWINGS

FIG. 1 is an external perspective view of an all-solid-state battery according to an embodiment;

FIG. 2 is a cross-sectional view of the all-solid-state battery taken along line II-II in FIG. 1;

FIG. 3 is a cross-sectional view of the all-solid-state battery taken along line III-III in FIG. 1;

FIG. 4 is an exploded perspective view of the all-solid-state battery;

FIG. 5 is a plan view of a positive electrode layer viewed in a laminating direction;

FIG. 6 is a cross-sectional view taken along line VI-VI in FIG. 5;

FIG. 7 is an enlarged view of a portion denoted by VII in FIG. 6;

FIG. 8 is an enlarged view of a portion denoted by VIII in FIG. 6; and

FIG. 9 is a flowchart illustrating a method of manufacturing the all-solid-state battery according to the embodiment.

### DETAILED DESCRIPTION OF THE INVENTION

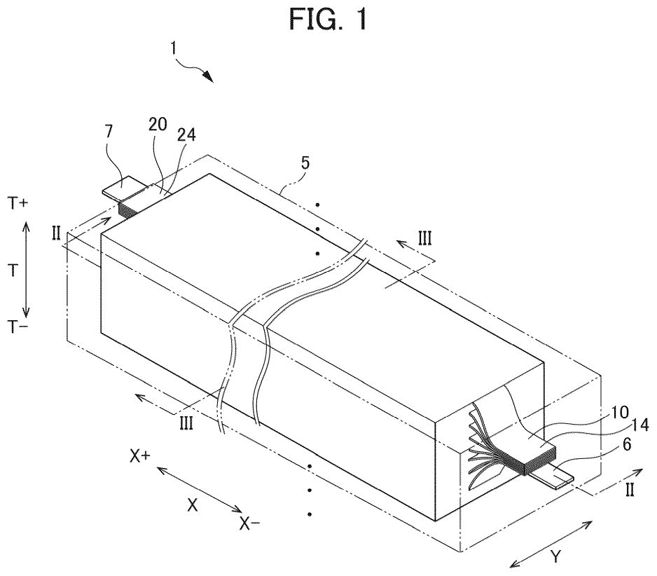

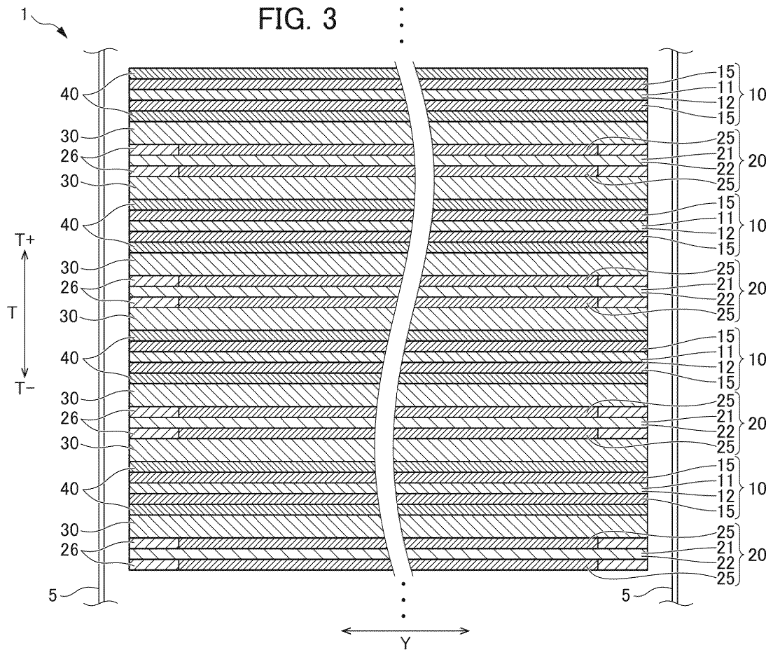

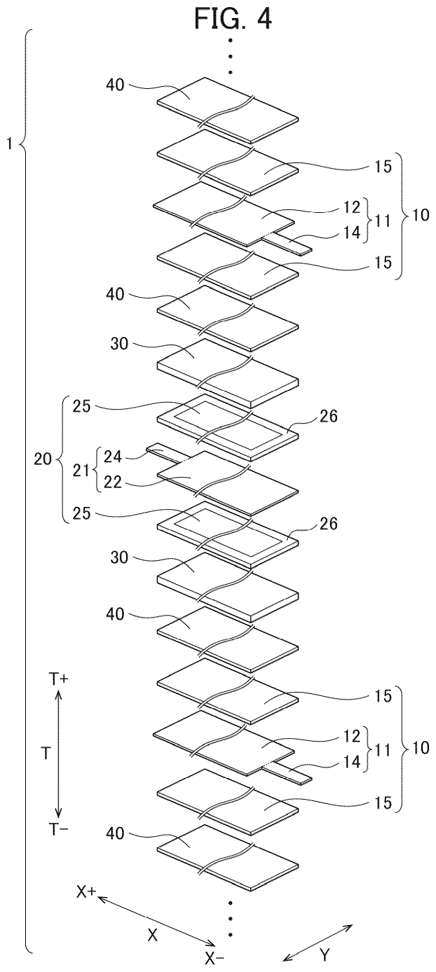

An all-solid-state battery 1 according to an embodiment of the present invention will be described below. The all-solid-state battery 1 may be of any type without particular limitation, and is, for example, an all-solid-state lithium battery that includes lithium ions as a charge transfer medium. As illustrated in FIGS. 1 to 4, the all-solid-state battery 1 has a structure in which positive electrode layers 20 and negative electrode layers 10 are laminated with solid electrolyte layers 30 interposed therebetween.

In the present specification, a direction in which the positive electrode layers 20 and the negative electrode layers 10 are laminated with the solid electrolyte layers 30 interposed therebetween is referred to as a “T direction”. The T direction corresponds to a laminating direction. One direction among directions orthogonal to the T direction is referred to as an “X direction”. The X direction corresponds to a first direction. A direction orthogonal to the T direction and the X direction is referred to as a “Y direction”. The Y direction corresponds to a second direction. A direction toward one side in the T direction is referred to as a “T+ direction”, and a direction opposite to the T+ direction is referred to as a “T− direction”. A direction toward one side in the X direction is referred to as an “X+ direction”, and a direction opposite to the X+ direction is referred to as an “X− direction”. A direction toward one side in the Y direction is referred to as a “Y+ direction”, and a direction opposite to the Y+ direction is referred to as a “Y− direction”.

### All-Solid-State Battery

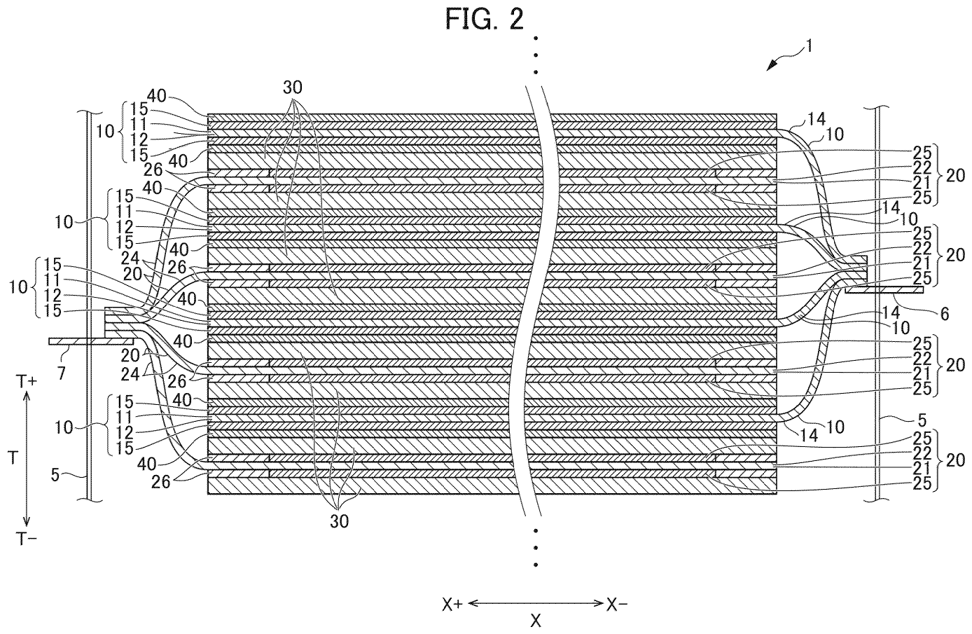

The all-solid-state battery 1 includes, for example, the plurality of negative electrode layers 10, the plurality of solid electrolyte layers 30, and the plurality of positive electrode layers 20. One negative electrode layer 10, one solid electrolyte layer 30, one positive electrode layer 20, and another solid electrolyte layer 30 are laminated in this order. The total number of laminated negative electrode layers 10 and positive electrode layers 20 is not particularly limited, and is preferably ten or more. It should be noted that in FIGS. 2 to 4, illustration of portions near the ends of the all-solid-state battery 1 in the T direction is omitted.

The all-solid-state battery 1 includes an exterior covering 5, a negative electrode tab lead 6, and a positive electrode tab lead 7. The exterior covering 5 forms a surface of the all-solid-state battery 1. The exterior covering 5 covers the laminate of the negative electrode layers 10, the solid electrolyte layers 30, and the positive electrode layers 20. The exterior covering 5 is composed of, for example, a resin. In FIG. 1, the exterior covering 5 is indicated by the two-dot chain lines. The negative electrode tab lead 6 is connected to bundled negative electrode tabs 14 (described later). The negative electrode tab lead 6 extends out from the exterior covering 5. The positive electrode tab lead 7 is connected to bundled positive electrode tabs 24 (described later). The positive electrode tab lead 7 extends out from the exterior covering 5.

### Negative Electrode Layer

The negative electrode layer 10 includes a negative electrode active material layer 15 and a negative electrode current collector layer 11. One negative electrode layer 10 includes, for example, one negative electrode current collector layer 11 and two negative electrode active material layers 15 provided to sandwich the negative electrode current collector layer 11 in the T direction.

The negative electrode active material layers 15 include a negative electrode active material. Examples of the negative electrode active material include, but are not limited to, lithium metal, lithium alloy, silicon (Si), silicon-based active materials such as silicon alloy, lithium transition metal oxides such as lithium titanate (Li₄Ti₅O₁₂), transition metal oxides such as TiO₂, Nb₂O₃, and WO₃, metal sulfides, metal nitrides, carbon materials such as graphite, soft carbon, and hard carbon, and metal indium. The negative electrode active material layers 15 are preferably composed of lithium metal. The negative electrode active material layers 15 may further include a solid electrolyte, a conductive aid, a binder, and the like.

Each negative electrode active material layer 15 has, for example, a flat plate shape with a plate surface extending along the X direction and the Y direction. When viewed in the T direction, the negative electrode active material layer 15 has a rectangular shape with a long side extending along the X direction, for example.

The negative electrode current collector layer 11 is provided adjacent to the negative electrode active material layers 15. The negative electrode current collector layer 11 is composed of, for example, copper, but is not limited to copper. The negative electrode current collector layer 11 has, for example, a foil shape. The negative electrode current collector layer 11 includes a negative electrode current collector layer-main body 12 and a negative electrode tab 14.

The negative electrode current collector layer-main body 12 is a portion of the negative electrode current collector layer 11 that overlaps with the adjacent negative electrode active material layers 15 in the T direction. When viewed in the T direction, the negative electrode current collector layer-main body 12 has a substantially rectangular shape with a long side extending in the X direction, for example.

The negative electrode tab 14 is a portion of the negative electrode current collector layer 11 that extends from the negative electrode current collector layer-main body 12 in a predetermined direction. The negative electrode tab 14 extends, for example, from the negative electrode current collector layer-main body 12 toward one side in the X direction (specifically, in the X-direction). The negative electrode tab 14 has a smaller dimension in the Y direction than the negative electrode current collector layer-main body 12. When viewed in the T direction, the negative electrode tab 14 has a substantially rectangular shape with a long side extending along the X direction, for example. The leading end portions of the plurality of negative electrode tabs 14 are bundled together.

### Solid Electrolyte Layer

The solid electrolyte layer 30 is provided between the negative electrode layer 10 and the positive electrode layer 20. The solid electrolyte layer 30 contains a solid electrolyte material. Examples of the solid electrolyte material include, but are not limited to, a sulfide solid electrolyte material and an oxide solid electrolyte material.

### Positive Electrode Layer

Each positive electrode layer 20 includes a positive electrode active material layer 25 and a positive electrode current collector layer 21. Specifically, for example, one positive electrode layer 20 includes one positive electrode current collector layer 21 and two positive electrode active material layers 25 sandwiching the one positive electrode current collector layer 21 in the T direction.

The positive electrode active material layers 25 include a positive electrode active material. Examples of the positive electrode active material include, but are not limited to, transition metal chalcogenides such as titanium disulfide, molybdenum disulfide, and niobium selenide, and transition metal oxides such as lithium nickelate (LiNiO₂), lithium manganate (LiMnO₂, LiMn₂O₄), and lithium cobaltate (LiCoO₂). The positive electrode active material layers 25 may further include a solid electrolyte, a conductive aid, a binder, and the like.

Each positive electrode active material layer 25 has, for example, a flat plate shape with a plate surface extending along the X direction and the Y direction. When viewed in the T direction, the positive electrode active material layer 25 has a rectangular shape with a long side extending along the X direction, for example.

For example, an insulating frame 26 is provided along an outer periphery of each positive electrode active material layer 25.

The insulating frame 26 includes a material having electronic insulation properties. Examples of the material having electronic insulation properties include, but are not limited to, insulating oxides such as alumina, resins such as polyvinylidene fluoride (PVDF), and rubbers such as styrene-butadiene rubber (SBR). The insulating frame 26 is preferably composed of alumina. The insulating frame 26 may have ionic conductivity.

The insulating frame 26 has a substantially flat plate shape with a plate surface extending along the X direction and the Y direction. When viewed in the T direction, the insulating frame 26 has a substantially rectangular frame shape with a long side extending along the X direction, for example.

The insulating frame 26 is capable of suppressing a short circuit in the all-solid-state battery 1 and improving strength of the all-solid-state battery 1.

The positive electrode current collector layer 21 is provided adjacent to the positive electrode active material layers 25. The positive electrode current collector layer 21 is composed of a current collector. Examples of the current collector include, but are not limited to, aluminum, copper, nickel, vanadium, iron, titanium, stainless steel, gold, platinum, and carbon. The positive electrode current collector layer 21 is composed of aluminum, for example. The positive electrode current collector layer 21 has, for example, a foil shape. The positive electrode current collector layer 21 includes a positive electrode current collector layer-main body 22 and a positive electrode tab 24.

The positive electrode current collector layer-main body 22 is a portion of the positive electrode current collector layer 21 that overlaps in the T direction with the positive electrode active material layer 25 adjacent to the positive electrode current collector layer 21. More specifically, the positive electrode current collector layer-main body 22 is a portion that overlaps in the T direction with at least one of the two positive electrode active material layers 25 adjacent to the positive electrode current collector layer 21. When viewed in the T direction, the positive electrode current collector layer-main body 22 has a rectangular shape with a long side extending in the X direction, for example.

In the case where the insulating frame 26 is provided along the positive electrode active material layer 25, “a portion of the positive electrode current collector layer 21 that overlaps in the T direction with the positive electrode active material layer 25 adjacent to the positive electrode current collector layer 21” refers to a portion of the positive electrode current collector layer 21 that overlaps in the T direction with at least one of the positive electrode active material layer 25 adjacent to the positive electrode current collector layer 21 or the insulating frame 26 provided along the outer periphery of the positive electrode active material layer 25.

The positive electrode tab 24 is a portion of the positive electrode current collector layer 21 that extends from the positive electrode current collector layer-main body 22 in a predetermined direction. The positive electrode tab 24 extends, for example, from the positive electrode current collector layer-main body 22 toward one side in the X direction (specifically, in the X+ direction). The positive electrode tab 24 has a smaller dimension in the Y direction than the positive electrode current collector layer-main body 22. When viewed in the T direction, the positive electrode tab 24 has a substantially rectangular shape with a long side extending in the X direction, for example. The leading end portions of the plurality of positive electrode tabs 24 are bundled together.

### Intermediate Layer

The all-solid-state battery 1 further includes, for example, a plurality of intermediate layers 40 each provided between the negative electrode layer 10 and the solid electrolyte layer 30 that are adjacent to each other.

The intermediate layer 40 includes, for example, carbon and a metal capable of alloying with lithium. Examples of the metal capable of alloying with lithium include, but are not limited to, Mg, Zn, Al, In, Si, Ge, Sn, Ag, Au, Pt, Pd, Pb, Sb, and Bi. Each intermediate layer 40 has, for example, a substantially rectangular plate shape with a plate surface extending in the X direction and the Y direction.

The intermediate layers 40 are more flexible than the negative electrode layers 10 and the solid electrolyte layers 30, and therefore, are easily brought into tight contact with the negative electrode layers 10 and the solid electrolyte layers 30. The intermediate layers 40 are capable of suppressing delamination between the negative electrode layer 10 and the solid electrolyte layer 30.

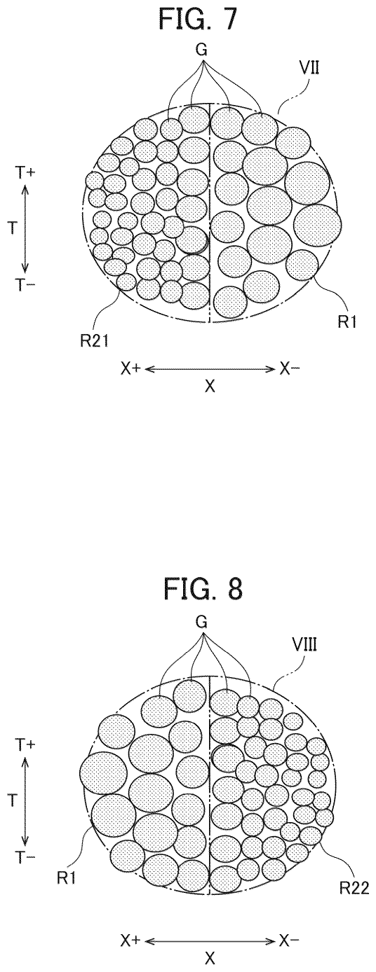

Here, each positive electrode current collector layer 21 is constituted of a polycrystalline body (see FIGS. 7 and 8). Individual crystal grains forming the polycrystalline body are referred to as “crystal grains G”.

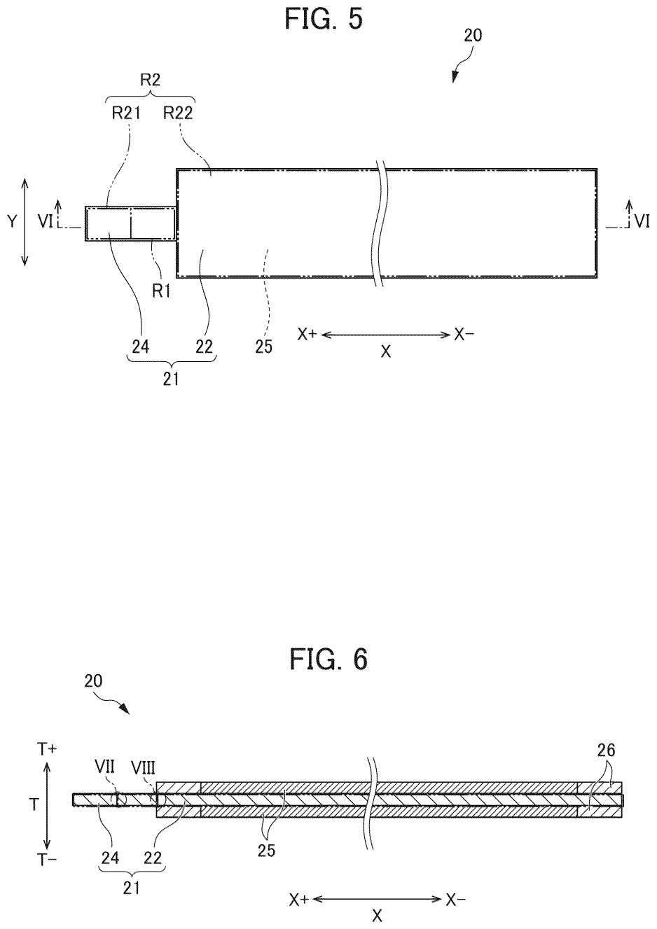

As illustrated in FIGS. 5, 6, and 8, a region defined in the positive electrode tab 24 and including the boundary portion between the positive electrode tab 24 and the positive electrode current collector layer-main body 22 is referred to as a first region R1. The first region R1 has a larger average grain size of the polycrystalline body than the positive electrode current collector layer-main body 22. In a region of the positive electrode current collector layer-main body 22 that is close to the first region R1, the grain size of the crystal grains G becomes smaller as the distance from the first region R1 increases, for example.

FIG. 5 is a plan view of the positive electrode layer 20 viewed in the direction from the T+ side toward the T− side. For convenience of description, FIG. 5 illustrates one positive electrode current collector layer 21 while omitting other positive electrode current collector layers 21 disposed toward the T+ side with respect to the one positive electrode current collector layer 21.

In the present specification, for the positive electrode current collector layer 21, a cross section that extends parallel to the T direction and the X direction and passes through a central portion in the Y direction of the positive electrode tab 24 is referred to as a “reference cross section”. FIG. 6 illustrates the reference cross section. The term “grain size of the polycrystalline body” means a diameter of a circle equivalent to the crystal grains G forming the polycrystalline body. The term “average grain size of the polycrystalline body in a region” means a median diameter (D50) of the crystal grains G in the region in the reference cross section.

The grain size of the crystal grains G in the positive electrode current collector layer 21 is measured by way of observation of the reference cross section with a scanning electron microscope (SEM).

The positive electrode current collector layer 21 preferably includes at least one of aluminum or an aluminum alloy. The crystal grains G are, for example, grains of aluminum.

As illustrated in FIGS. 5, 6, and 7, a region defined in the positive electrode tab 24 and located toward the side (X+ side) opposite to the positive electrode current collector layer-main body 22 with respect to the first region R1 is referred to as a second region R2 (or “tab-side second region R21”). The second region R2 preferably has a smaller average grain size of the polycrystalline body than the first region R1. In a region within the tab-side second region R21 that is close to the first region R1, the grain size of the crystal grains G becomes smaller as the distance from the first region R1 increases, for example.

The first region R1 has an end located toward the side (X+ side) opposite to the positive electrode current collector layer-main body 22, and the end is in proximity to, for example, a central portion in the X direction of the positive electrode tab 24. The end of the first region R1 located toward the side (X+ side) opposite to the positive electrode current collector layer-main body 22 may be closer to the positive electrode current collector layer-main body 22 (X− side) than the central portion in the X direction of the positive electrode tab 24 is.

In the present specification, “central portion in the X direction of the positive electrode tab 24” means a portion of the positive electrode tab 24 that overlaps with a virtual straight line extending parallel to the Y direction and passing through a central portion in the X direction between the X+ side end and the X− side end of the positive electrode tab 24.

A region defined in the positive electrode current collector layer 21 and located toward the side (X− side) opposite to the tab-side second region R21 with respect to the first region R1 is referred to as a “main body− side second region R22”. The tab-side second region R21 and the main body-side second region R22 are collectively referred to as the “second region R2”. The first region R1 has a larger average grain size of the polycrystalline body than the second region R2, for example.

The first region R1 has an end that is located toward the side (X− side) opposite to the tab-side second region R21, and the end is located, for example, at a boundary portion between the positive electrode tab 24 and the positive electrode current collector layer-main body 22. The end of the first region R1 located toward the side (X− side) opposite to the tab-side second region R21 may be at an intermediate portion in the X direction of the positive electrode current collector layer-main body 22.

The average grain size of the polycrystalline body of the first region R1 is less than 3.0 μm, and preferably 0.5 μm or more and less than 3.0 μm. The average grain size of the polycrystalline body of the positive electrode current collector layer 21 is preferably 0.1 μm or more and less than 0.5 μm. The average grain size of the polycrystalline body of the main body− side second region R22 is preferably 0.2 μm or more and less than 0.5 μm.

The thickness of the positive electrode current collector layer 21 is preferably 0.005 mm or more and 0.05 mm or less.

In the present specification, “thickness of the positive electrode current collector layer” means a dimension in the T direction of the positive electrode current collector layer. More specifically, the thickness of the positive electrode current collector layer is an average value of the dimensions in the T direction of the positive electrode current collector layer that are measured at intersections of a straight line extending parallel to the X direction and passing through a central portion in the Y direction of the positive electrode current collector layer and four straight lines extending parallel to the Y direction and dividing the positive electrode current collector layer into five equal parts in the X direction.

The positive electrode active material layer 25 preferably includes a lithium nickel cobalt manganese composite oxide.

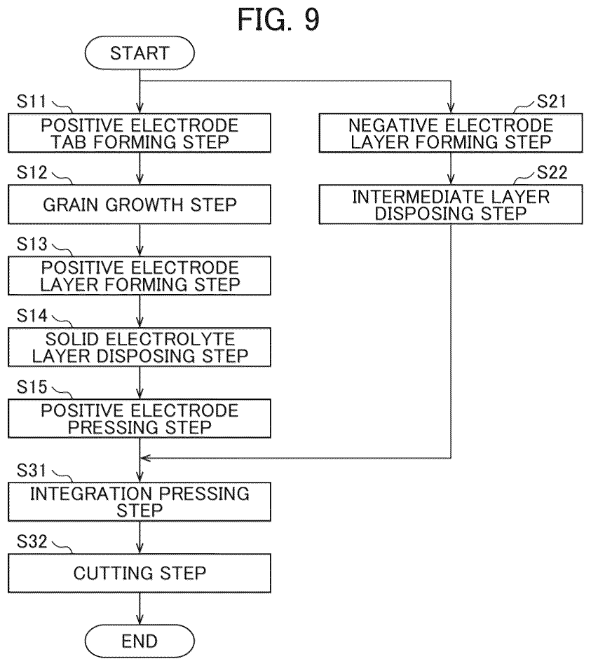

Method of Manufacturing All-Solid-State Battery Next, a method of manufacturing the all-solid-state battery 1 according to the present embodiment will be described with reference to FIG. 9.

As illustrated in FIG. 9, first, a raw material for the positive electrode current collector layer is prepared. The raw material is a polycrystalline body and includes the positive electrode current collector layer-main body 22 on which the positive electrode active material layers 25 are to be disposed, and the positive electrode tab 24 extending from the positive electrode current collector layer-main body 22. For example, an aluminum foil is prepared, and an end portion of the aluminum foil is cut off to form the positive electrode tab 24 (positive electrode tab forming step S11).

Next, a boundary portion between the positive electrode tab 24 and the positive electrode current collector layer-main body 22 is heated to form the first region that has a larger average grain size of the polycrystalline body than the positive electrode current collector layer-main body 22 (grain growth step S12). In the grain growth step S12, a mid-infrared heating device is used to heat the boundary portion between the positive electrode tab 24 and the positive electrode current collector layer-main body 22 within a predetermined temperature range for a predetermined heating time.

In the grain growth step S12, the region to become the first region R1 is heated at a temperature of, for example, 150° C. or higher and 420° C. or lower. In the grain growth step S12, the region to become the first region R1 is heated for a period of, for example, 1 minute or longer and 500 minutes or shorter. This allows for growth of the crystal grains G in the region that becomes the first region R1.

In the grain growth step S12, the region to become the first region R1 and the region to become the second region R2 may be heated. In that case, at least one of the following conditions is satisfied: the region to become the first region R1 is heated at a higher temperature than the region to become the second region R2, or the region to become the first region R1 is heated for a longer time than the region to become the second region R2. The region to become the second region R2 is heated at a temperature of, for example, 70° C. or higher and lower than 150° C. The region to become the second region R2 is heated for a period of, for example, 1 minute or longer and 360 minutes or shorter.

Next, the positive electrode current collector layer 21 and the positive electrode active material layers 25 are laminated together to form the positive electrode layer 20 (positive electrode layer forming step S13). In this step, the insulating frame 26 is formed on the positive electrode current collector layer 21 of the positive electrode layer 20 in accordance with the design dimensions of the all-solid-state battery 1 in finished form.

The grain growth step S12 may be performed after the positive electrode layer forming step S13.

Next, the positive electrode layer 20 and the solid electrolyte layer 30 are laminated (solid electrolyte layer disposing step S14). In the solid electrolyte layer disposing step S14, transfer pressing is performed such that for example, a slurry for forming the solid electrolyte layer 30 is applied to, and pressed on, the positive electrode layer 20. In this step, the temperature is, for example, room temperature (e.g., 10° C. to 35° C.), and the pressure is, for example, 50 MPa to 500 MPa.

Next, the positive electrode layer 20 having the solid electrolyte layer 30 laminated thereon is pressed (positive electrode pressing step S15). In the positive electrode pressing step S15, the positive electrode active material layers 25 and the positive electrode current collector layer 21 superposed on each other are pressed. The positive electrode pressing step S15 densifies the positive electrode layer 20. In order to densify the positive electrode layer 20, the positive electrode pressing step S15 is carried out at a temperature of 25° C. to 100° C. at a pressure of 800 MPa to 1200 MPa, for example.

The grain growth step S12 is preferably performed before the positive electrode pressing step S15.

Meanwhile, the negative electrode layer 10 is formed by disposing the negative electrode active material layer 15 on the negative electrode current collector layer 11 (negative electrode layer forming step S21). The negative electrode current collector layer 11 has the negative electrode tab 14.

Next, the intermediate layer 40 is disposed on the negative electrode active material layer 15 laminated on the negative electrode current collector layer 11 (intermediate layer disposing step S22). In the intermediate layer disposing step, transfer pressing is performed such that, for example, the intermediate layer 40 is pressed on and applied to the negative electrode active material layer 15 by using a transfer roller. In this step, the temperature is, for example, room temperature (e.g., 10° C. to 35° C.), and the pressure is, for example, 50 MPa to 800 MPa.

Thereafter, the positive electrode layer 20 on which the solid electrolyte layer 30 is laminated and the negative electrode layer 10 on which the intermediate layer 40 is laminated are superposed and pressed by a pressing device (integration pressing step S31). As a result, the positive electrode layer 20, the negative electrode layer 10, the solid electrolyte layer 30, and the intermediate layer 40 are integrated. In the integration pressing step S31, the positive electrode layer 20, the negative electrode layer 10, and the solid electrolyte layer 30 are superposed and pressed. In this step, the temperature is, for example, 25° C. to 100° C., and the pressure is, for example, 500 MPa to 900 MPa. The integration pressing step S31 integrates the positive electrode layer 20 and the negative electrode layer 10 with each other, and simultaneously densifies the solid electrolyte layer 30.

The pressing pressure in the positive electrode pressing step S15 is higher than the pressing pressure in the integration pressing step S31.

The grain growth step S12 does not necessarily have to be performed before the positive electrode pressing step S15. However, the grain growth step S12 is preferably performed at least before the integration pressing step S31.

Next, the resultant laminate is cut with a rotary cutter (cutting step S32).

Next, although not illustrated, leading end portions of the plurality of negative electrode tabs 14 are bundled and connected to the negative electrode tab lead 6. Leading end portions of the plurality of positive electrode tabs 24 are bundled and connected to the positive electrode tab lead 7. Next, the laminate is covered with a resin that serves as the exterior covering 5. A leading end portion of the positive electrode tab lead 7 and a leading end portion of the negative electrode tab lead 6 are exposed from the exterior covering 5.

The transfer of the solid electrolyte layer 30 to the positive electrode layer 20 in the solid electrolyte layer disposing step S14, the pressing of the positive electrode layer 20 in the positive electrode pressing step S15, the lamination of the negative electrode layer 10 on the positive electrode layer 20 before the integration, and the integration pressing in the integration pressing step S31 are performed on both surfaces of the positive electrode layer 20. The transfer of the negative electrode active material layer 15 to the negative electrode current collector layer 11 in the negative electrode layer forming step S21 and the transfer of the intermediate layer 40 to the negative electrode layer 10 in the intermediate layer disposing step S22 are performed on both surfaces of the negative electrode layer 10. As a result, the all-solid-state battery 1 has a structure in which each current collector layer has symmetrically laminated layers on the upper and lower surfaces, as illustrated in FIGS. 1 to 3.

By the method described above, the all-solid-state battery 1 illustrated in FIG. 1 is manufactured.

The method of manufacturing the all-solid-state battery 1 according to the present embodiment may include a step other than those described above. The method of manufacturing the all-solid-state battery is not limited to the above-described method, and a known method other than the above can be employed.

### Effects of Embodiment

According to the above-described embodiment, the following effects can be obtained.

The all-solid-state battery 1 of the above-described embodiment includes the positive electrode current collector layers 21 constituted of a polycrystalline body. The first region R1 defined in the positive electrode tab 24 and including the boundary portion between the positive electrode tab 24 and the positive electrode current collector layer-main body 22 has a larger average grain size of the polycrystalline body than the positive electrode current collector layer-main body 22. The average grain size of the polycrystalline body in the first region R1 is less than 3.0 μm.

Among regions of each positive electrode current collector layer 21, the region near the root of the positive electrode tab 24 is considered to easily fracture because the region is likely to be affected by expansion and contraction of the all-solid-state battery 1. The above-described configuration, in which the first region R1 that has a relatively large average grain size of the polycrystalline body is formed in the region near the root of the positive electrode tab 24, makes it possible to increase the strength of the region near the root of the positive electrode tab 24. Furthermore, since the average grain size of the polycrystalline body in the first region R1 is less than 3.0 μm, the flexibility of the positive electrode tab 24 can be sufficiently ensured. This makes it possible to reduce or prevent fracture of the positive electrode current collector layer 21. Thus, the all-solid-state battery 1 having excellent durability can be provided.

If the average grain size of the polycrystalline body of the positive electrode current collector layer 21 increases, the electrical resistance in the positive electrode current collector layer 21 will increase, and the battery performance of the all-solid-state battery 1 may deteriorate. Due to the above-described configuration, in which the positive electrode current collector layer-main body 22 has a small average grain size of the polycrystalline body, an increase in electrical resistance in the positive electrode current collector layer-main body 22 can be reduced or prevented.

Furthermore, since the positive electrode current collector layer-main body 22 is laminated on other layers, the positive electrode current collector layer-main body 22 is less likely to give rise to a problem pertaining to its strength. Therefore, it is possible to improve the durability of the all-solid-state battery 1 while ensuring the battery performance of the all-solid-state battery 1.

Furthermore, since the average grain size of the polycrystalline body in the first region R1 is less than 3.0 μm, an increase in electrical resistance in the first region R1 can be reduced or prevented. This makes it possible to more satisfactorily reduce or prevent deterioration of the battery performance of the all-solid-state battery 1.

In the all-solid-state battery 1 of the above-described embodiment, each positive electrode current collector layer 21 preferably includes at least one of aluminum or an aluminum alloy.

According to this configuration, since grains of aluminum easily grow by being heated, the first region R1 can be satisfactorily formed by heating the positive electrode current collector layer 21.

Furthermore, since aluminum has excellent corrosion resistance, it is possible to easily ensure the durability of the positive electrode current collector layers 21 over a long period of time.

According to the all-solid-state battery 1 of the above-described embodiment, the second region R2 (tab-side second region R21) defined in the positive electrode tab 24 and located toward the side (X+ side) opposite to the positive electrode current collector layer-main body 22 with respect to the first region R1 preferably has a smaller average grain size of the polycrystalline body than the first region R1.

Each positive electrode tab 24 is joined to other positive electrode tabs 24 while being in a bent state. For this reason, it is considered preferable that the positive electrode tab 24 are flexible to an appropriate extent. In particular, it is considered preferable that a region near the leading end of the positive electrode tab 24 is flexible. On the other hand, an increase in the average grain size of the polycrystalline body of the positive electrode tab 24 will harden the positive electrode current collector layer 21. In such a case, the positive electrode tab 24 may easily experience buckling when the all-solid-state battery 1 expands. However, the above-described configuration, in which the tab-side second region R21 has a small average grain size of the polycrystalline body, makes it possible to easily ensure the flexibility of the positive electrode tab 24. In particular, the above-described configuration makes it possible to easily ensure the flexibility near the leading end of the positive electrode tab 24. As a result, it is possible to reduce or prevent buckling of the positive electrode current collector layer 21.

According to the all-solid-state battery 1 of the above-described embodiment, the end of the first region R1 that is located toward the side (X+ side) opposite to the positive electrode current collector layer-main body 22 may be located closer to the positive electrode current collector layer-main body 22 (X− side) than the central portion in the X direction of the positive electrode tab 24 is.

According to this configuration, the positive electrode current collector layer 21 is allowed to have a relatively hard region that reaches the vicinity of its end, thereby making it possible to satisfactorily reduce the likelihood of fracture of the positive electrode current collector layer 21. Furthermore, by adjusting the position in the X direction of the end of the first region R1 that is toward the side opposite to the positive electrode current collector layer-main body 22, it is possible to adjust the balance between the effect of reducing or preventing the fracture of the positive electrode current collector layer 21 and the effect of reducing or preventing the buckling of the positive electrode current collector layer 21.

According to the all-solid-state battery 1 of the above-described embodiment, the average grain size of the polycrystalline body in the first region R1 is preferably 0.5 μm or more and less than 3.0 μm.

According to this configuration, the strength of the first region can be easily ensured by increasing the average grain size of the polycrystalline body in the first region to an appropriate extent, thereby making it possible to reduce or prevent the buckling of the positive electrode tab. The flexibility of the first region can be easily ensured by reducing the average grain size of the polycrystalline body in the first region to an appropriate extent, thereby making it possible to reduce or prevent the fracture of the positive electrode tab. As a result, the durability of the all-solid-state battery can be further satisfactorily improved.

According to the all-solid-state battery 1 of the above-described embodiment, the thickness of the positive electrode current collector layer 21 is preferably 0.005 mm or more and 0.05 mm or less.

If the positive electrode current collector layer 21 is too small, the positive electrode current collector layer 21 would have an insufficient strength. If the positive electrode current collector layer 21 is too large, excessive electrical resistance would occur in the positive electrode current collector layer 21. However, the above-described configuration makes it possible to more satisfactorily improve the durability of the all-solid-state battery 1 while ensuring the battery performance of the all-solid-state battery 1.

According to the all-solid-state battery 1 of the above-described embodiment, the positive electrode active material layers 25 preferably include a lithium nickel cobalt manganese composite oxide.

According to the above configuration, the thermal durability of the positive electrode active material layer 25 can be improved, and therefore the positive electrode current collector layer 21 and the positive electrode active material layer 25 can be easily heated simultaneously.

The positive electrode active material layers 25 may contract during charge of the all-solid-state battery 1. The contraction of the positive electrode active material layers 25 can suppress expansion of the all-solid-state battery 1 during charge, thereby making it possible to reduce or prevent the fracture of the positive electrode current collector layers 21.

The method of manufacturing the all-solid-state battery 1 of the above-described embodiment includes the grain growth step S12 including: preparing a raw material for the positive electrode current collector layer, the raw material being a polycrystalline body and having the positive electrode current collector layer-main body 22 on which the positive electrode active material layers 25 are to be disposed and having the positive electrode tab 24 extending from the positive electrode current collector layer-main body 22; and heating the boundary portion between the positive electrode tab 24 and the positive electrode current collector layer-main body 22 to form the first region R1 that has a larger average grain size of the polycrystalline body than the positive electrode current collector layer-main body 22.

Heating the positive electrode current collector layer 21 can produce growth of the crystal grains G forming the polycrystalline body of the positive electrode current collector layer 21. According to this manufacturing method, by performing the grain growth step S12, the crystal grains G forming the polycrystalline body can be grown in the region near the boundary portion between the positive electrode tab 24 and the positive electrode current collector layer-main body 22, whereby the first region R1 can be formed in the positive electrode current collector layer 21.

The method of manufacturing the all-solid-state battery 1 according to the above-described embodiment includes the integration pressing step S31 including superposing and pressing the positive electrode layer 20, the negative electrode layer 10, and the solid electrolyte layer 30. The grain growth step S12 is preferably performed before the integration pressing step S31.

When the positive electrode current collector layer 21 is pressed, the crystal grains G in the positive electrode current collector layer 21 may be inhibited from growing. However, the manufacturing method of the embodiment can produce satisfactory growth of the crystal grains G in the positive electrode current collector layer 21, thereby easily allowing the first region R1 and a region of the positive electrode current collector layer 21 other than the first region R1 (i.e., the second region R2) to have different average grain sizes of the polycrystalline body.

The method of manufacturing the all-solid-state battery 1 according to the above-described embodiment includes the positive electrode pressing step S15 including pressing the positive electrode active material layers 25 and the positive electrode current collector layer 21 superposed on each other. The grain growth step S12 is more preferably performed before the positive electrode pressing step S15.

The manufacturing method of the embodiment can produce more satisfactory growth of the crystal grains G in the positive electrode current collector layer 21, thereby easily allowing the first region R1 and the region of the positive electrode current collector layer 21 other than the first region R1 (i.e., the second region R2) to have different average grain sizes of the polycrystalline body.

The present invention is not limited to the configuration of the above-described embodiment, and can be appropriately modified and worked within a range in which the spirit of the present invention is unchanged. It should be noted that a combination of two or more of the individual desirable configurations described in the above embodiment is also encompassed in the present invention.

### EXAMPLES

1. Manufacturing of all-Solid-State Battery

### Example 1

### Preparation of Positive Electrode Layer

As a positive electrode current collector, an aluminum foil (average grain size of polycrystalline body: approximately 0.4 μm) having a length of 500 mm, a width of 700 mm, and a thickness of 12.5 μm was provided. A portion of the positive electrode current collector where a positive electrode active material layer and an insulating frame are not to be laminated was cut off so that a tab having a length of 35 mm and a width of 50 mm was formed.

Next, the tab was heated under conditions of a temperature of 400° C. and a heating time of 2 minutes.

Next, 80 parts by mass of a lithium nickel cobalt manganese composite oxide (NCM622) as a positive electrode active material, 17 parts by mass of argyrodite-type sulfide solid electrolyte as a solid electrolyte material, 2 parts by mass of carbon black as a conductive aid, and 1 part by mass of styrene butadiene rubber (SBR)-based binder as a binder were mixed. The resultant mixture was dispersed in 43 parts by mass of butyl butyrate to prepare a positive electrode active material layer slurry. The prepared positive electrode active material layer slurry was applied to both surfaces of the positive electrode current collector using a bar coater so as to achieve an area weight of 27 mg/cm² in a dried state, and thereafter, dried to form a positive electrode active material layer having a length of 520 mm, a width of 90 mm, a thickness of 80 μm, and a density of 3.50 g/cm³.

Subsequently, an insulating frame having a length of 530 mm, a width of 103 mm, and a thickness of 78 μm was formed along the outer periphery of the positive electrode active material layer by intermittent coating. In the above-described manner, a positive electrode layer was prepared.

### Preparation of Solid Electrolyte Layer Transfer Sheet

A dispersion liquid of an argyrodite-type sulfide solid electrolyte (median diameter: 3.0 μm) was applied to a carrier sheet and dried to form an argyrodite-type sulfide solid electrolyte layer, thereby preparing a solid electrolyte layer transfer sheet.

### Preparation of Negative Electrode Layer

A copper foil having a thickness of 10 μm was provided as a negative electrode current collector. A portion of the negative electrode current collector where a negative electrode active material layer and an intermediate layer are not to be laminated was cut off so that a tab having a length of 35 mm and a width of 50 mm was formed. A metal lithium foil having a thickness of 7 μm was laminated on a surface of the copper foil to prepare a negative electrode layer.

### Preparation of Intermediate Layer Transfer Sheet

Sn particles (median diameter: 0.07 μm) as metal nanoparticles and acetylene black (median diameter: 0.05 μm) as amorphous carbon in a total amount of 95 parts by mass were mixed with 5 parts by mass of a PVDF-based binder as a binder. The resultant mixture was dispersed in 1000 parts by mass of N-methyl-2-pyrrolidone (NMP) to prepare an intermediate layer slurry. The prepared intermediate layer slurry was applied to a carrier sheet and dried to produce an intermediate layer transfer sheet having a final thickness of 5 μm.

### Fabrication of All-Solid-State Battery

The solid electrolyte layer of the solid electrolyte layer transfer sheet was placed on the positive electrode active material layer of the positive electrode layer, and then the positive electrode layer and the solid electrolyte layer transfer sheet were press-bonded at a bonding pressure of 50 MPa, followed by peeling off the carrier sheet of the solid electrolyte layer transfer sheet, thereby fabricating a solid electrolyte layer-positive electrode layer laminate. The intermediate layer of the intermediate layer transfer sheet was transferred onto the metal lithium foil on the negative electrode layer, and then the negative electrode layer and the intermediate layer were press-bonded at a bonding pressure of 300 MPa, thereby fabricating an intermediate layer-negative electrode layer laminate. The solid electrolyte layer-positive electrode layer laminates and the intermediate layer-negative electrode layer laminates were alternately laminated. The resultant laminate including the solid electrolyte layer-positive electrode layer laminates and the intermediate layer-negative electrode layer laminates was press-bonded at a bonding pressure of 500 MPa, thereby fabricating a positive electrode layer-solid electrolyte layer-intermediate layer-negative electrode layer laminate. The positive electrode layer-solid electrolyte layer-intermediate layer-negative electrode layer laminate was cut to predetermined dimensions to obtain a laminate that functions as one all-solid-state battery. The obtained laminate was covered with an exterior covering, and the tabs of the positive electrode layer was connected to a positive electrode tab lead, and the tabs of the negative electrode layer was connected to a negative electrode tab lead, and thereafter, the exterior covering was sealed to obtain an all-solid-state battery.

### Comparative Example 1

An all-solid-state battery was fabricated in the same manner as in Example 1, except that the tab was heated at 95° C.

### Comparative Example 2

An all-solid-state battery was fabricated in the same manner as in Example 1, except that the tab was heated at 550° C.

### 2. Evaluation

### Measurement of Average Grain Size of Polycrystalline Body

The average grain size of the polycrystalline body in the first region of the positive electrode tab (may be simply referred to as “average grain size in the first region”) was measured for each all-solid-state battery. To measure the average grain size in the first region, the all-solid-state battery was disassembled so that the positive electrode current collector layer was exposed, and the first region was observed with a SEM. For each of the example and comparative examples, 60 all-solid-state batteries were subjected to the measurement of the average grain size in the first region. For each of the example and comparative examples, the range of the average grain size in the first region was checked.

### Capacity Retention Rate Measurement

The all-solid-state batteries fabricated in Example 1 and Comparative Examples 1 and 2 were subjected to a cycle test in which charge and discharge were repeated at an upper limit charge voltage of 4.2 V, a lower limit discharge voltage of 2.5 V, and a C rate of 0.1 C, and the capacity retention rate after 500 cycles was measured. For each of the example and comparative examples, when the capacity retention rate was less than 90%, the battery was evaluated as “poor”, and when the capacity retention rate was 90% or more, the battery was evaluated as “good”.

### Observation of State of Positive Electrode Tab

The all-solid-state batteries after the above-described cycle test were subjected to cross-sectional observation using CT to observe the state of the positive electrode tab. The all-solid-state batteries were evaluated in terms of the presence or absence of buckling (also referred to as tab folding) of the positive electrode tab and the presence or absence of fracture of the positive electrode tab.

When the region of the positive electrode current collector including the positive electrode tab was folded into a Z-shape, the result was determined as “buckling present”. When buckling was observed in none of the 60 all-solid-state batteries, the result was evaluated as “good”. When the buckling was observed in one or more of the 60 all-solid-state batteries, the result was evaluated as “poor”.

When a cut or a crack was formed in the boundary portion between the positive electrode tab and the positive electrode current collector layer-main body, the result was determined as “fracture present”. When the fracture was observed in none of the 60 all-solid-state batteries, the result was evaluated as “good”. When the fracture was observed in one or more of the 60 all-solid-state batteries, the result was evaluated as “poor”.

### Overall Evaluation

When the evaluation regarding the capacity retention rate measurement, the evaluation regarding the presence or absence of the buckling, and the evaluation regarding the presence or absence of the fracture were all “good”, the overall evaluation was made as “good”. When at least one of the evaluation of the capacity retention rate, the evaluation regarding the presence or absence of the buckling, or the evaluation regarding the presence or absence of the fracture was “poor”, the overall evaluation was made as “poor”.

### 3. Measurement Results

Table 1 shows, for each of the example and comparative examples, the range of the average grain size (μm) of the polycrystalline body in the first region of the positive electrode tab, the capacity retention rate (%) and the evaluation regarding the capacity retention rate, the number of all-solid-state batteries determined as “buckling present” and the evaluation regarding the presence or absence of the buckling, the number of all-solid-state batteries determined as “fracture present” and the evaluation regarding the presence or absence of the fracture, and the overall evaluation.

TABLE 1

| | | | | | Presence/Absence | | Presence/Absence | | |
|---|---|---|---|---|---|---|---|---|---|
| | | | | | of Buckling | | of Fracture | | |
| | | Range of Average | Capacity Retention | | Number of | | Number of | | |
| | | Grain Size in | Rate Measurement | | Batteries | | Batteries | | |
| | Range of Average | Positive Electrode | Capacity | | Determined | | Determined | | |
| | Grain Size in First | Current Collector | Retention | | as | | as | | |
| | Region | Layer-Main Body | Rate | | “Buckling | | “Fracture | | Overall |
| | (μm) | (μm) | (%) | Evaluation | Present” | Evaluation | Present” | Evaluation | Evaluation |
| Comparative Example 1 | 0.2 or more and | 0.2 or more and | 55 | Poor | 50/60 | Poor | 0/60 | Good | Poor |
| | less than 0.5 | less than 0.5 | | | | | | | |
| Example 1 | 0.5 or more and | 0.2 or more and | 98 | Good | 0/60 | Good | 0/60 | Good | Good |
| | less than 3.0 | less than 0.5 | | | | | | | |
| Comparative Example 2 | 3.0 or more and | 0.2 or more and | 60 | Poor | 0/60 | Good | 60/60 | Poor | Poor |
| | less than 6.0 | less than 0.5 | | | | | | | |
| Comparative Example 3 | 0.5 or more and | 0.5 or more and | 50 | Poor | 50/60 | Poor | 0/60 | Good | Poor |
| | less than 3.0 | less than 3.0 | | | | | | | |

The results in Table 1 demonstrate that the all-solid-state battery of Example 1 has a good capacity retention rate in spite of the repetition of charge and discharge, and buckling and fracture of the positive electrode tab are less likely to occur. In contrast, the all-solid-state battery of Comparative Example 1, in which the first region of the positive electrode tab has a relatively small average grain size of the polycrystalline body, exhibited a low capacity retention rate after the repetition of charge and discharge, and the buckling of the positive electrode tab was likely to occur. The all-solid-state battery of Comparative Example 2, in which the first region of the positive electrode tab has a relatively large average grain size of the polycrystalline body, exhibited a low capacity retention rate after the repetition of charge and discharge, and although the buckling of the positive electrode tab was less likely to occur, the fracture of the positive electrode tab was likely to occur.

In Example 1, the average grain size of the polycrystalline body in the positive electrode current collector layer-main body (the main body-side second region) was 0.2 μm or more and less than 0.5 μm. In Example 1, the first region had a larger average grain size of the polycrystalline body than the positive electrode current collector layer-main body. As such, Comparative Example 3 was prepared as a comparative example in which the first region and the positive electrode current collector layer-main body had the same average grain size of the polycrystalline body. Comparative Example 3 was subjected to the above-described capacity retention rate measurement and subsequent observation of the positive electrode tab.

The all-solid-state batteries of Comparative Example 3 were fabricated in the same manner as in Example 1, except that the positive electrode current collector layer-main body was heated under conditions of a temperature of 400° C. and a heating time of 2 minutes.

In Comparative Example 3, the average grain size of the polycrystalline body of both the first region and the positive electrode current collector layer-main body portion was 0.2 μm or more and less than 3.0 μm. In Comparative Example 3, the capacity retention rate after 500 cycles was 50%, and the result was evaluated as “poor”. In Comparative Example 3, the buckling had occurred.

A comparison between Example 1 and Comparative Example 3 shows that in the case where the first region has a larger average grain size of the polycrystalline body than the positive electrode current collector layer-main body, a satisfactory capacity retention rate is achieved while reducing the likelihood of the buckling of the positive electrode tab.

What is claimed is:

1. An all-solid-state battery, comprising:
a negative electrode layer and a positive electrode layer laminated together with a solid electrolyte layer interposed therebetween, the positive electrode layer including a positive electrode active material layer and a positive electrode current collector layer, wherein
a direction in which the negative electrode layer and the positive electrode layer are laminated is defined as a laminating direction, and one direction among directions orthogonal to the laminating direction is defined as a first direction,
the positive electrode current collector layer includes a positive electrode current collector layer-main body and a positive electrode tab, the positive electrode current collector layer-main body overlapping with the positive electrode active material layer in the laminating direction, the positive electrode tab extending from the positive electrode current collector layer-main body toward one side in the first direction,
the positive electrode current collector layer is constituted of a polycrystalline body,
a first region defined in the positive electrode tab and including a boundary portion between the positive electrode tab and the positive electrode current collector layer-main body has an average grain size of the polycrystalline body that is larger than an average grain size of the polycrystalline body of the positive electrode current collector layer-main body, and
the average grain size of the polycrystalline body in the first region is less than 3.0 μm.

2. The all-solid-state battery according to claim 1, wherein the positive electrode current collector layer comprises at least one of aluminum or an aluminum alloy.

3. The all-solid-state battery according to claim 1, wherein a second region defined in the positive electrode tab and located toward a side opposite to the positive electrode current collector layer-main body with respect to the first region has an average grain size of the polycrystalline body that is smaller than the average grain size of the polycrystalline body in the first region.

4. The all-solid-state battery according to claim 1, wherein the first region has an end located toward a side opposite to the positive electrode current collector layer-main body, and the end is closer to the positive electrode current collector layer-main body than a central portion in the first direction of the positive electrode tab is.

5. The all-solid-state battery according to claim 1, wherein the average grain size of the polycrystalline body in the first region is 0.5 μm or more and less than 3.0 μm.

6. The all-solid-state battery according to claim 1, wherein the positive electrode current collector layer has a thickness of 0.005 mm or more and 0.05 mm or less.

7. The all-solid-state battery according to claim 1, wherein the positive electrode active material layer comprises a lithium nickel cobalt manganese composite oxide.

8. A method of manufacturing the all-solid-state battery according to claim 1, the method comprising:
a grain growth step including
preparing a raw material for the positive electrode current collector layer, the raw material being constituted of the polycrystalline body and having the positive electrode current collector layer-main body on which the positive electrode active material layer is to be disposed and having the positive electrode tab extending from the positive electrode current collector layer-main body, and
heating the boundary portion between the positive electrode tab and the positive electrode current collector layer-main body to form the first region whose average grain size of the polycrystalline body is larger than that of the positive electrode current collector layer-main body.

9. The method according to claim 8, further comprising:
an integration pressing step including superposing and pressing the positive electrode layer, the negative electrode layer, and the solid electrolyte layer, wherein
the grain growth step is performed before the integration pressing step.

10. The method according to claim 9, further comprising:
a positive electrode pressing step including pressing the positive electrode active material layer and the positive electrode current collector layer superposed on each other, wherein
the grain growth step is performed before the positive electrode pressing step.
